(19) United States
(12) Patent Application Publication
(10) Pub. No.: US 2017/0128786 A1
(43) Pub. Date: May 11, 2017

(54) GOLF BALL INCORPORATING AT LEAST ONE STIFFENED LAYER

(71) Applicant: Acushnet Company, Fairhaven, MA (US)

(72) Inventors: Michael J. Sullivan, Old Lyme, CT (US); Robert Blink, Newport, RI (US); David A. Bulpett, Boston, MA (US); Brian Comeau, Berkley, MA (US)

(73) Assignee: Acushnet Company, Fairhaven, MA (US)

(21) Appl. No.: 14/936,761

(22) Filed: Nov. 10, 2015

(51) Int. Cl. A63B 37/00; C08L 75/02; C08L 77/00; C08L 67/00; C08K 5/09; C08L 83/04; C08K 5/05; C08K 5/053; C08L 91/00; C08L 75/04; C08L 23/02

(52) U.S. Cl. CPC A63B 37/0051; C08L 75/04; C08L 75/02; C08L 77/00; C08L 67/00; C08L 23/02; C08L 83/04; C08K 5/05; C08K 5/053; C08L 91/00; C08K 5/09

(57) ABSTRACT

Golf ball comprising at least one layer L_{S} comprising material L_{M} formed from a polymeric composition and a plurality of liquid droplets that are formed throughout the polymeric composition by combining the polymeric composition and a liquid that is immiscible in the polymeric composition. The polymeric composition has a modulus M_{S1} and material L_{M} has a modulus M_{S2} wherein (M_{S2}/M_{S1})>1. The polymeric composition may comprise at least one polyurethane, polyurea, ionomer, polyamide, polyester, polyolefin, and/or silicone. The liquid may be, for example, at least one of ionic liquids, alcohols, glycols, glycerol, silicone oils, hydrocarbon oils, or liquid fatty acids. Liquid droplet diameter may be up to about 100 nm or up to about 100 μm, and a droplet may be spherical or aspherical, and sometimes be oblate or prolate. An aspherical droplet may be ovoid or ellipsoid. M_{S2} may be from about 1,000-80,000 psi.; or 70,000-500,000 psi or greater.

### FIELD OF THE INVENTION

Golf balls incorporating materials such as balata, polybutadiene, ionomer resins, polyurethanes, polyureas, polyamides, polyesters, and/or polyolefins that can be stiffened.

### BACKGROUND OF THE INVENTION

Golf balls are made in a variety of constructions and compositions. In this regard, each of the golf ball core, intermediate layer, and cover may be single layered or comprise multiple layers. Examples of golf ball materials range from balata to polybutadiene, ionomer resins, polyurethanes, polyureas, polyamides, polyesters, and/or polyolefins. Typically, outer layers are formed about the spherical outer surface of an inner golf ball component via compression molding, casting, or injection molding.

Golf ball manufacturers continuously experiment with golf ball constructions and material formulations in order to target and improve aerodynamic and/or inertial properties and achieve desired feel without sacrificing durability. One often efficient and cost effective approach for accomplishing these goals is to find new ways to modify/change the physical properties of golf ball materials such as those identified above in order to achieve a desired characteristic.

In this regard, stiffer layers have numerous beneficial uses. A stiffer inner or outer cover layer can reduce spin and increase coefficient of restitution at high swing speeds. Furthermore, inner and outer core layers having different stiffnesses can provide good flight distance accompanied by comfortable and soft feel. Meanwhile, a higher flexural modulus material in the inner core layer and/or an inner cover layer and a lower flexural modulus material in the outer cover layer and a can impart good feel to a golf ball during short shots and putting.

For example, in U.S. Pat. No. 7,776,947 of Jordan, mid-acid ionomers were modified with nucleating agents in order to advantageously increase flexural modulus. Nucleating agents are capable of modifying the properties of the ionomers by changing their semicrystalline nature such as their degree of crystallinity and the distribution of crystallite sizes. Id. The more uniform crystalline texture produced by the added nucleating agent may result in increased flexural modulus. Id.

Golf ball manufacturers have also increased layer stiffness by incorporating particulates, with the degree of reinforcement being commensurate with the particulate aspect ratio. For example, Jordan et al., U.S. Patent Application Publ. No. 2007/0191526 discloses golf balls wherein at least one of the layers is formed from a host matrix comprised of a fully neutralized ethylene acid copolymer or other ionomer resin and high aspect ratio nano clays preferably having a 50% average dry particle size of 6 μm or less and a 10% average dry particle size of 2 μm or less with a preferred aspect ratio of 100 to 150.

And U.S. Publ. No. 2015/0273275 of Blink et al. discloses nanocrystalline cellulose particulates incorporated in a polymer matrix in at least one layer of a golf ball. The nanocrystalline cellulose particulates (particle size of less than about 1000 nm) are incorporated in a polymer matrix in an amount of about 1-10 pphr for improving golf ball stiffness, durability, and reduced driver spin-rate. Blink et al. teaches that the very small sizes of these particulates create an advantageously larger surface area for interacting directly with the surrounding polymer matrix, thereby increasing the particulate's effect on the resultant composition.

Meanwhile, interpenetrating polymer networks or “IPNs” have also been used to improve the compatibility between different polymers in multi-polymer blend systems in order to target golf ball properties such as flexural modulus by minimizing immiscibility of the polymers and reduce the phase size of each phase separated polymer. See, e.g., U.S. Pat. No. 8,353,788 of Kuntimaddi et al. (“the '788Patent”), e.g., @Col. 5, lines ll. 1-14 and Col. 10, l. 58-Col. 11, l. 26.

There remains a need, however, for durable and high quality golf balls wherein stiffer layers can be targeted and created simply and cost effectively without incorporating particulates, which are generally anisotropic, and/or without the need to improve compatibility between ingredients. The golf balls of the present invention and method for making same address and solve these needs.

### SUMMARY OF THE INVENTION

Accordingly, a golf ball of the invention incorporates at least one layer wherein fluid droplets, rather than particulates, are formed within a polymeric composition to target and achieve desired stiffness without sacrificing golf ball durability and overall high quality. Specifically, the invention is directed to a golf ball comprising at least one layer L_{S} comprising a material L_{M} that is formed from a polymeric composition and a plurality of liquid droplets; wherein the plurality of liquid droplets are formed throughout the polymeric composition by combining the polymeric composition and a liquid that is immiscible in the polymeric composition. The polymeric composition may have a modulus M_{S1} and the material L_{M} may have a modulus M_{S2} wherein (M_{S2}/M_{S1})>1. The polymeric composition may comprise, for example, at least one of polyurethane, polyurea, ionomer, polyamide, polyester, polyolefin, silicone, or a combination thereof.

Meanwhile, the liquid may comprise, for example, at least one of ionic liquids, alcohols, glycols, glycerol, silicone oils, hydrocarbon oils, or liquid fatty acids. In some embodiments, the liquid may comprise a mixture. Layer L_{S} may in some embodiments be formed using dispersing aids such as surfactants.

The liquid is a liquid at the temperature of golf ball use. In one embodiment, the liquid is partially immiscible in the polymeric composition. In another embodiment, the liquid is completely immiscible in the polymeric composition.

There are numerous methods for combining the liquid and the polymeric composition. For example, the liquid and the polymeric composition may be combined by at least one of high shear mixing, kneading, or compounding. In one embodiment, the liquid droplets may form throughout the polymeric composition during any of these operations.

The resulting stiffness of material L_{M} may be targeted by coordinating liquid droplet size and the surface tension at the liquid/solid interface—that is, the boundary between each liquid droplet and the surrounding the polymeric composition.

Thus, liquid droplet diameter can influence modulus M_{S2} of material L_{M} and may be, for example, up to about 100 nm, or up to about 500 nm, or less than about 5 μm, or from about 1 μm to about 10 μm, or from about 2 μm to about 8 μm, or from about 1 μm to about 5 μm, or up to about 5 μm, or of up to about 10 μm. Embodiments are also envisioned wherein at least one droplet has a diameter of from about 100 nm to about 5 μm. In some embodiments, one or more droplets may have a diameter of up to about 50 μm, and/or from about 10 μm to about 50 μm, and/or up to about 100 μm.

A droplet may be spherical or aspherical. In one embodiment, at least some of the droplets may be oblate and/or prolate. And an embodiment is envisioned wherein at least some asymmetrical droplets may be ovoid and/or ellipsoid.

Resulting M_{S2} is greater than M_{S1}. That being said, M_{S2} may be targeted to achieve any desired stiffness or modulus, for example, from about to about 1,000 psi to about 80,000 psi, or from about to about 70,000 psi to about 500,000 psi, but the modulus will be increased over that of the polymeric composition. A benefit of a golf ball of the invention is that the possible modulus of a layer can be increased as desired by combining a polymeric composition having a particular modulus (M_{S1}) with the droplets within a conventional golf ball manufacturing process.

Non-limiting examples of such a modulus increase are as follows. In one embodiment, (M_{S2}/M_{S1})>1.10. In another embodiment, (M_{S2}/M_{S1})>1.20. In yet another embodiment, (M_{S2}/M_{S1})>1.30. In still another embodiment (M_{S2}/M_{S1})>1.50. Of course, embodiments are also envisioned wherein (M_{S2}/M_{S1})>2.0 or greater.

Liquid droplet size and surface tension at an interface between each liquid droplet and the polymeric composition may be coordinated to achieve M_{S2}>M_{S1}.

Advantageously, Lₛ may be incorporated in a golf ball of the invention in any desirable construction. For example, in one embodiment, Lₛ may be at least one of a core or intermediate layer. In another embodiment, Lₛ is a cover layer. In yet another embodiment, Lₛ is a coating layer disposed about a cover layer. In still another embodiment, Lₛ is at least one of opaque, transparent or translucent.

The invention is also directed to a method of making a golf ball comprising providing at least one layer L_{S} that comprises a material L_{M}; wherein L_{M} is formed by combining a polymeric composition and a liquid that is immiscible in the polymeric composition such that a plurality of liquid droplets form throughout the polymeric composition.

### BRIEF DESCRIPTION OF THE DRAWINGS

FIG. 1A is a cross-sectional view of a golf ball with an intermediate layer L_{S} comprising material L_{M} that is formed from a polymeric composition and a plurality of liquid droplets;

FIG. 1B is a cross-sectional view of a golf ball with a cover layer L_{S} comprising material L_{M} that is formed from a polymeric composition and a plurality of liquid droplets;

FIG. 2A and FIG. 2B are enlarged views of each layer section highlighted in FIG. 1A and FIG. 1B, respectively;

FIG. 3 is an enlarged view of the layer section highlighted in FIG. 1B;

FIG. 4 is an enlarged view of a liquid droplet within the polymeric composition of the enlarged view of the layer section highlighted in FIG. 3; and

FIG. 5 is an enlarged view of an alternatively substantially spherically shaped liquid droplet within the polymeric composition of the enlarged view of the layer section highlighted in FIG. 3.

### DETAILED DESCRIPTION

Combining a polymeric composition and a liquid as discussed and disclosed herein to form material L_{M} that is formed from the polymeric composition and a plurality of liquid droplets creates many options for suitable layer compositions for incorporation in golf balls. In a golf ball of the invention, stiffer layers or layers having a higher modulus can be formed without the need to incorporate particulates or IPNs. Great versatility now exists regarding possible stiffnesses for golf ball layers wherein incompatibility between the polymeric composition and the liquid is actually a benefit in forming the plurality of droplets within the polymeric composition to increase the modulus of the polymeric composition.

The liquid may be a non-polymer liquid. The liquid is a liquid at the temperature of golf ball use. Golf ball use tends to occur under temperatures ranging from about 40° F. to about 100° F. However, it is envisioned that liquids may be selected that are liquids at any conceivable golf ball use temperature such as ranging from less than about 40° F. to greater than about 100° F.

The liquid and the polymeric composition are immiscible such that the plurality of liquid droplets form throughout the polymeric composition. As used herein, the term immiscible means incompatible in that a combination of the liquid and the polymeric composition results in a layer composition characterized by two distinct phases.

Conventionally, immiscibility is typically evidenced in a blend either by the existence of multiple glass transition temperatures therein, or, if the glass transition temperatures of the individual polymers comprising the blend are initially in close proximity, by testing the properties of the final blend such as mechanical, morphology, etc. Immiscible polymer blends can exhibit opacity, delamination, double glass transition, or a combination of these properties. And if the refractive indices are the same for the two polymers, even an immiscible blend may appear transparent. In golf balls of the invention, the polymeric composition and liquid are immiscible at least to the extent that a plurality of liquid droplets are formed within resulting material L_{M}.

The liquid forming each droplet is a liquid at the temperature of golf ball use—for example, during play on a course, since the stiffness of the resulting material L_{M} is achieved by coordinating liquid droplet size and surface tension at the liquid/solid interface or boundary between each liquid droplet and the surrounding the polymeric composition. As used herein, the phrase “surface tension” is denoted by γ and refers to an isotropic surface stress. See, e.g., Stiffening Solids with Liquid Inclusions; R W Style, R Boltyanskiy, B Allen, K E Jensen, H P Foote, J S Wettlaufer, and E R Dufresne; July, 2014, hereby incorporated herein by reference in its entirety. For liquids, surface energy and surface stress are isotropic and identical. In contrast, for solids, surface stress and energy are generally anisotropic and distinct. Id.

At the meeting of the at least two phases, there is a phase boundary that defines the edge of each phase between a droplet and the polymeric composition. The average size of the droplets within the resulting material L_{M} can be experimentally measured using, for example, atomic force microscopy, scanning electron microscopy, transmission electron microscopy, or other appropriate characterization apparatus.

As used herein, the term “diameter” is used with respect to both substantially spherical droplets as well as aspherical droplets (non-spherical, asymmetric or irregularly shaped droplets). However, the measurements are different. For substantially spherical droplets, the diameter is the straight line that passes through the center of the droplet and whose endpoints lie on the surface thereof. Concerning aspherical droplets, the diameter is the “characteristic length” of the droplets—that is, the longest cross-section distance of the droplet.

Liquid droplet diameter may be, for example, up to about 100 nm, or up to about 500 nm, or less than about 5 μm, or from about 1 μm to about 10 μm, or from about 2 μm to about 8 μm, or from about 1 μm to about 5 μm, or up to about 5 μm, or from about 100 nm to about 5 μm. In other embodiments, liquid droplet diameter may be up to about 50 μm, or up to about 10 μm, or from about 50 μm to about 100 μm, or from about 10 μm to about 50 μm. In some embodiments, the plurality of liquid droplets within resulting material L_{M} may have quite similar diameters. However, embodiments are also envisioned wherein the plurality of liquid droplets have different diameters such as diameters falling within two or more of the diameter ranges disclosed herein.

Material L_{M} can be relatively stiff or relatively flexible but has a greater flex modulus and hardness than the flex modulus and hardness of the polymeric composition.

In some embodiments, L_{M} may have a flex modulus lower limit of 20,000 or 30,000 or 40,000 or 50,000 or 60,000 or 70,000 or 80,000 or 90,000 or 100,000; and a flex modulus upper limit of 110,000 or 120,000 or 130,000 psi or 140,000 or 160,000 or 180,000 or 200,000 or 300,000 or 400,000 or 500,000 psi or greater. Alternatively, in other embodiments, L_{M} may have a flex modulus lower limit of 1,000 or 5,000 or 10,000 or 15,000 or 20,000 or 25,000 or 30,000 psi; and a flex modulus upper limit of 40,000 or 45,000 or 50,000 or 60,000 or 70,000 or 80,000 psi.

In some embodiments, L_{M} may have a tensile modulus lower limit of 20,000 or 30,000 or 40,000 or 50,000 or 60,000 or 70,000 or 80,000 or 90,000 or 100,000; and a tensile modulus upper limit of 110,000 or 120,000 or 130,000 psi or 140,000 or 160,000 or 180,000 or 200,000 or 300,000 or 400,000 or 500,000 psi or greater. Alternatively, in other embodiments, L_{M} may have a tensile modulus lower limit of 1,000 or 5,000 or 10,000 or 15,000 or 20,000 or 25,000 or 30,000 psi and a tensile upper limit of 40,000 or 45,000 or 50,000 or 60,000 or 70,000 or 80,000 psi.

In some embodiments, L_{M} may have a compressive modulus lower limit of 20,000 or 30,000 or 40,000 or 50,000 or 60,000 or 70,000 or 80,000 or 90,000 or 100,000; and a compressive modulus upper limit of 110,000 or 120,000 or 130,000 psi or 140,000 or 160,000 or 180,000 or 200,000 or 300,000 or 400,000 or 500,000 psi or greater. Alternatively, in other embodiments, L_{M} may have a compressive modulus lower limit of 1,000 or 5,000 or 10,000 or 15,000 or 20,000 or 25,000 or 30,000 psi and a compressive modulus upper limit of 40,000 or 45,000 or 50,000 or 60,000 or 70,000 or 80,000 psi.

In one embodiment, L_{M} has a hardness of 40 Shore D or greater, or 50 Shore D or greater, or 60 Shore D or greater, or 70 Shore D or greater; or within a range having a lower limit of 40 or 50 or 60 Shore D and an upper limit of 80 or 90 or 100 Shore D. In another embodiment, L_{M} has a hardness of 30 Shore D or less, or 40 Shore D or less, or 50 Shore D or less, or 60 Shore D or less. In yet another embodiment, the hardness falls within a range having a lower limit of 15 or 30 or 40 or 50 Shore D and an upper limit of 60 or 70 or 80 or 85 Shore D.

Alternatively, L_{M} may have a hardness of 60 Shore C or greater, or 70 Shore C or greater, or 80 Shore C or greater, or 90 Shore C or greater. In another embodiment, L_{M} may have a hardness of 60 Shore C or less; or 70 Shore C or less, or 80 Shore C or less, or 95 Shore C or less.

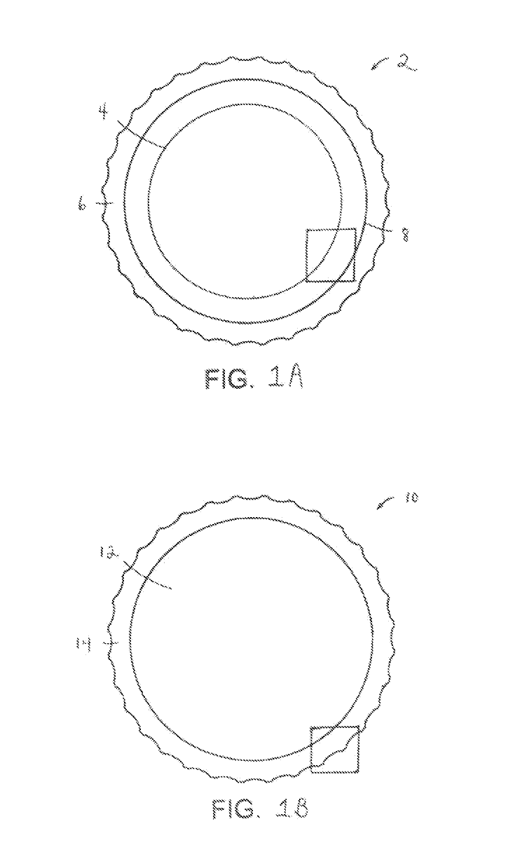

FIGS. 1A, 1B, 2A, 2B, and 3-5 depict at least two embodiments of a golf ball of the invention. Referring to FIG. 1A, golf ball 2 comprises core 4 and cover 6, with intermediate layer 8 being a layer L_{S} comprising material L_{M} that is formed from a polymeric composition and a plurality of liquid droplets. While in FIG. 1A, layer L_{S} is an intermediate layer, it is envisioned that layer L_{S} may comprise any or all of a golf ball core, cover, intermediate layer(s) and coating layer(s). For example, FIG. 1B depicts golf ball 10 comprising core 12 and cover 14, wherein cover 14 is a layer L_{S} comprising material L_{M} that is formed from a polymeric composition and a plurality of liquid droplets.

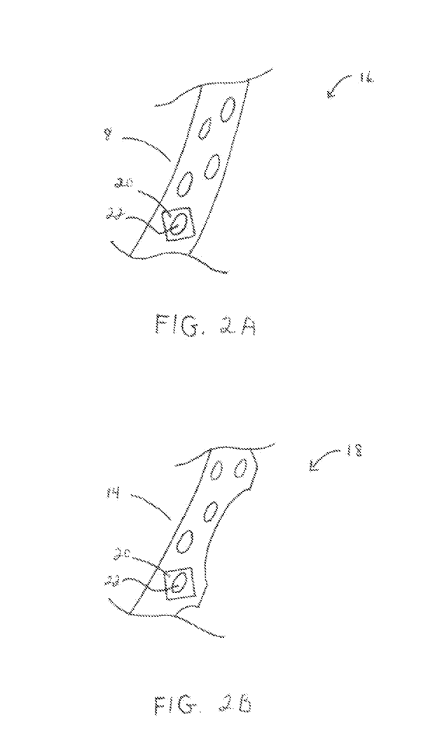

FIGS. 2A and 2B are enlarged sections of a layer L_{S}, namely intermediate layer 8 and cover 14, respectively. As is shown in each of FIGS. 2A and 2B, enlarged sections 16, 18 of intermediate layer 8 and cover 14 are each formed from material L_{M} that is formed from a polymeric composition 20 and a plurality of liquid droplets 22.

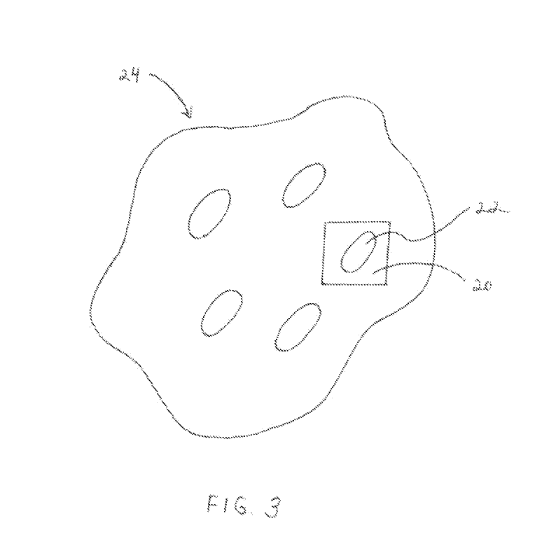

FIG. 3 is an enlarged section 24 of intermediate layer 8 and/or cover 14 and depicts polymeric composition 20 and a plurality of liquid droplets 22. By coordinating liquid droplet size and surface tension at boundaries between each liquid droplet within the polymeric composition, the resulting material L_{M} of a layer L_{S} may be stiffened.

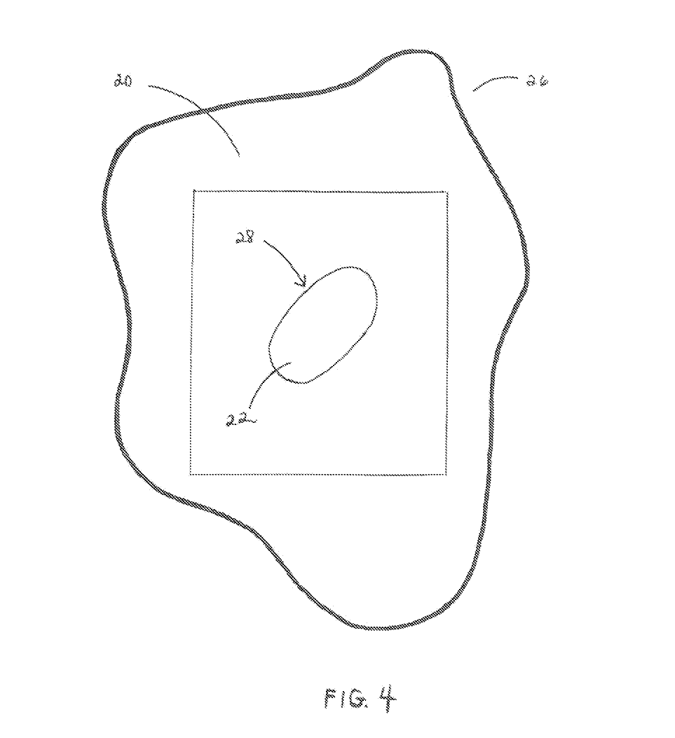

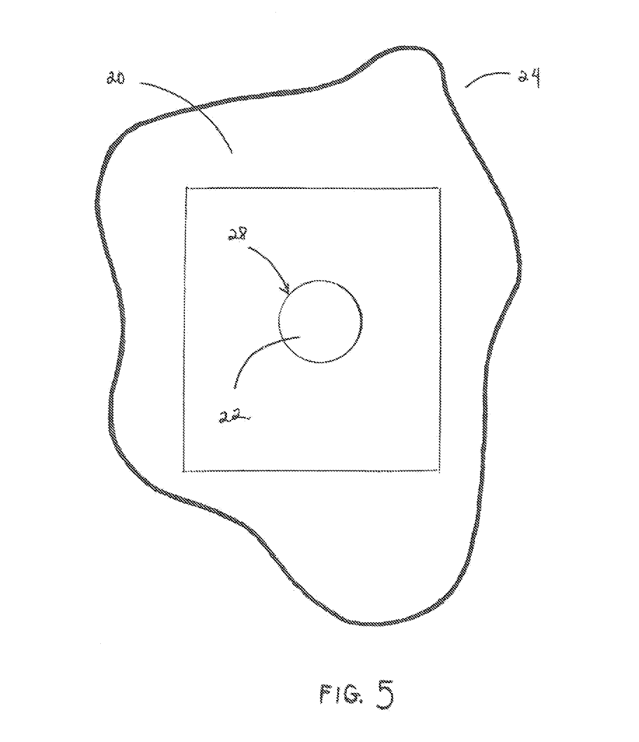

FIG. 4 is an enlarged section 26 of enlarged section 24 of FIG. 3 and highlights an interface 28 between polymeric composition 20 and one aspherical liquid droplet 22. And FIG. 5 depicts an alternative embodiment of FIG. 4, wherein at least one liquid droplet 22 of the enlarged section 24 may be substantially spherical rather than aspherical.

Test methods for measuring the flex modulus and hardness of the materials are described below. In some instances, it may be more feasible to measure the hardness of the golf ball layer (that is, “hardness on the ball”), and this test method also is described below.

By the term, “modulus” as used herein, it is meant flexural modulus which is the ratio of stress to strain within the elastic limit (when measured in the flexural mode) and is similar to tensile modulus. This property is used to indicate the bending stiffness of a material. The flexural modulus, which is a modulus of elasticity, is determined by calculating the slope of the linear portion of the stress-strain curve during the bending test. The formula used to calculate the flexural modulus from the recorded load (F) and deflection (D) is:

$${E}_{B} = \frac{3}{4} \frac{{FL}^{3}}{{bd}^{ 3} D}$$

wherein,

L=span of specimen between supports (m);

b=width (in.); and

d=thickness (in.)

If the slope of the stress-strain curve is relatively steep, the material has a relatively high flexural modulus meaning the material resists deformation. The material is more rigid. If the slope is relatively flat, the material has a relatively low flexural modulus meaning the material is more easily deformed. The material is more flexible. Flexural modulus can be determined in accordance with ASTM D790 standard among other testing procedures. In turn, the tensile modulus may be determined by methods such as ASTM D638 or D412; and compressive modulus may be determined, for example, according to ASTM D 695.

The center hardness of a core is obtained according to the following procedure. The core is gently pressed into a hemispherical holder having an internal diameter approximately slightly smaller than the diameter of the core, such that the core is held in place in the hemispherical portion of the holder while concurrently leaving the geometric central plane of the core exposed. The core is secured in the holder by friction, such that it will not move during the cutting and grinding steps, but the friction is not so excessive that distortion of the natural shape of the core would result. The core is secured such that the parting line of the core is roughly parallel to the top of the holder. The diameter of the core is measured 90 degrees to this orientation prior to securing. A measurement is also made from the bottom of the holder to the top of the core to provide a reference point for future calculations. A rough cut is made slightly above the exposed geometric center of the core using a band saw or other appropriate cutting tool, making sure that the core does not move in the holder during this step. The remainder of the core, still in the holder, is secured to the base plate of a surface grinding machine. The exposed ‘rough’ surface is ground to a smooth, flat surface, revealing the geometric center of the core, which can be verified by measuring the height from the bottom of the holder to the exposed surface of the core, making sure that exactly half of the original height of the core, as measured above, has been removed to within 0.004 inches. Leaving the core in the holder, the center of the core is found with a center square and carefully marked and the hardness is measured at the center mark according to ASTM D-2240. Additional hardness measurements at any distance from the center of the core can then be made by drawing a line radially outward from the center mark, and measuring the hardness at any given distance along the line, typically in 2 mm increments from the center. The hardness at a particular distance from the center should be measured along at least two, preferably four, radial arms located 180° apart, or 90° apart, respectively, and then averaged. All hardness measurements performed on a plane passing through the geometric center are performed while the core is still in the holder and without having disturbed its orientation, such that the test surface is constantly parallel to the bottom of the holder, and thus also parallel to the properly aligned foot of the durometer.

The outer surface hardness of a golf ball layer is measured on the actual outer surface of the layer and is obtained from the average of a number of measurements taken from opposing hemispheres, taking care to avoid making measurements on the parting line of the core or on surface defects, such as holes or protrusions. Hardness measurements are made pursuant to ASTM D-2240 “Indentation Hardness of Rubber and Plastic by Means of a Durometer.” Because of the curved surface, care must be taken to ensure that the golf ball or golf ball subassembly is centered under the durometer indenter before a surface hardness reading is obtained. A calibrated, digital durometer, capable of reading to 0.1 hardness units is used for the hardness measurements. The digital durometer must be attached to, and its foot made parallel to, the base of an automatic stand. The weight on the durometer and attack rate conforms to ASTM D-2240.

In certain embodiments, a point or plurality of points measured along the “positive” or “negative” gradients may be above or below a line fit through the gradient and its outermost and innermost hardness values. In an alternative preferred embodiment, the hardest point along a particular steep “positive” or “negative” gradient may be higher than the value at the innermost portion of the inner core (the geometric center) or outer core layer (the inner surface)—as long as the outermost point (i.e., the outer surface of the inner core) is greater than (for “positive”) or lower than (for “negative”) the innermost point (i.e., the geometric center of the inner core or the inner surface of the outer core layer), such that the “positive” and “negative” gradients remain intact.

As discussed above, the direction of the hardness gradient of a golf ball layer is defined by the difference in hardness measurements taken at the outer and inner surfaces of a particular layer. The center hardness of an inner core and hardness of the outer surface of an inner core in a single-core ball or outer core layer are readily determined according to the test procedures provided above. The outer surface of the inner core layer (or other optional intermediate core layers) in a dual-core ball are also readily determined according to the procedures given herein for measuring the outer surface hardness of a golf ball layer, if the measurement is made prior to surrounding the layer with an additional core layer. Once an additional core layer surrounds a layer of interest, the hardness of the inner and outer surfaces of any inner or intermediate layers can be difficult to determine. Therefore, for purposes of the present invention, when the hardness of the inner or outer surface of a core layer is needed after the inner layer has been surrounded with another core layer, the test procedure described above for measuring a point located 1 mm from an interface is used.

Also, it should be understood that there is a fundamental difference between “material hardness” and “hardness as measured directly on a golf ball.” For purposes of the present invention, material hardness is measured according to ASTM D2240 and generally involves measuring the hardness of a flat “slab” or “button” formed of the material. Surface hardness as measured directly on a golf ball (or other spherical surface) typically results in a different hardness value. The difference in “surface hardness” and “material hardness” values is due to several factors including, but not limited to, ball construction (that is, core type, number of cores and/or cover layers, and the like); ball (or sphere) diameter; and the material composition of adjacent layers. It also should be understood that the two measurement techniques are not linearly related and, therefore, one hardness value cannot easily be correlated to the other. Shore hardness (for example, Shore C or Shore D hardness) was measured according to the test method ASTM D-2240.

A golf ball of the invention may otherwise have any known construction as long as there is at least one layer L_{S} comprising a material L_{M} that is formed from a polymeric composition and a plurality of liquid droplets; wherein the plurality of liquid droplets are formed throughout the polymeric composition by combining the polymeric composition and a liquid that is immiscible in the polymeric composition.

In one embodiment of a golf ball of the invention for example, the first layer is formed about a rubber-containing core, wherein the base rubber may be selected from polybutadiene rubber, polyisoprene rubber, natural rubber, ethylene-propylene rubber, ethylene-propylene diene rubber, styrene-butadiene rubber, and combinations of two or more thereof. A preferred base rubber is polybutadiene. Another preferred base rubber is polybutadiene optionally mixed with one or more elastomers selected from polyisoprene rubber, natural rubber, ethylene propylene rubber, ethylene propylene diene rubber, styrene-butadiene rubber, polystyrene elastomers, polyethylene elastomers, polyurethane elastomers, polyurea elastomers, metallocene-catalyzed elastomers, and plastomers.

Suitable curing processes include, for example, peroxide curing, sulfur curing, radiation, and combinations thereof. In one embodiment, the base rubber is peroxide cured. Organic peroxides suitable as free-radical initiators include, for example, dicumyl peroxide; n-butyl-4,4-di(t-butylperoxy) valerate; 1,1-di(t-butylperoxy)3,3,5-trimethylcyclohexane; 2,5-dimethyl-2,5-di(t-butylperoxy) hexane; di-t-butyl peroxide; di-t-amyl peroxide; t-butyl peroxide; t-butyl cumyl peroxide; 2,5-dimethyl-2,5-di(t-butylperoxy)hexyne-3; di(2-t-butyl-peroxyisopropyl)benzene; dilauroyl peroxide; dibenzoyl peroxide; t-butyl hydroperoxide; and combinations thereof. Peroxide free-radical initiators are generally present in the rubber compositions in an amount within the range of 0.05 to 15 parts, preferably 0.1 to 10 parts, and more preferably 0.25 to 6 parts by weight per 100 parts of the base rubber. Cross-linking agents are used to cross-link at least a portion of the polymer chains in the composition. Suitable cross-linking agents include, for example, metal salts of unsaturated carboxylic acids having from 3 to 8 carbon atoms; unsaturated vinyl compounds and polyfunctional monomers (e.g., trimethylolpropane trimethacrylate); phenylene bismaleimide; and combinations thereof. Particularly suitable metal salts include, for example, one or more metal salts of acrylates, diacrylates, methacrylates, and dimethacrylates, wherein the metal is selected from magnesium, calcium, zinc, aluminum, lithium, and nickel. In a particular embodiment, the cross-linking agent is selected from zinc salts of acrylates, diacrylates, methacrylates, and dimethacrylates. When the cross-linking agent is zinc diacrylate and/or zinc dimethacrylate, the agent typically is included in the rubber composition in an amount within the range of 1 to 60 parts, preferably 5 to 50 parts, and more preferably 10 to 40 parts, by weight per 100 parts of the base rubber.

In a preferred embodiment, the cross-linking agent used in the rubber composition of the core is zinc diacrylate (“ZDA”). Adding the ZDA curing agent to the rubber composition makes the core harder and improves the resiliency and COR of the ball. —As a result, the overall durability, toughness, and impact strength of the ball is improved.

Sulfur and sulfur-based curing agents with optional accelerators may be used in combination with or in replacement of the peroxide initiators to cross-link the base rubber. High energy radiation sources capable of generating free-radicals may also be used to cross-link the base rubber. Suitable examples of such radiation sources include, for example, electron beams, ultra-violet radiation, gamma radiation, X-ray radiation, infrared radiation, heat, and combinations thereof.

The rubber compositions may also contain “soft and fast” agents such as a halogenated organosulfur, organic disulfide, or inorganic disulfide compound. Particularly suitable halogenated organosulfur compounds include, but are not limited to, halogenated thiophenols. Preferred organic sulfur compounds include, but not limited to, pentachlorothiophenol (“PCTP”) and a salt of PCTP. A preferred salt of PCTP is ZnPCTP. A suitable PCTP is sold by the Struktol Company (Stow, Ohio) under the tradename, A95. ZnPCTP is commercially available from EchinaChem (San Francisco, Calif.). These compounds also may function as cis-to-trans catalysts to convert some cis-1,4 bonds in the polybutadiene to trans-1,4 bonds. Peroxide free-radical initiators are generally present in the rubber compositions in an amount within the range of 0.05 to 10 parts and preferably 0.1 to 5 parts. Antioxidants also may be added to the rubber compositions to prevent the breakdown of the elastomers. Other ingredients such as accelerators (for example, tetra methylthiuram), processing aids, processing oils, dyes and pigments, wetting agents, surfactants, plasticizers, as well as other additives known in the art may be added to the composition. Generally, the fillers and other additives are present in the rubber composition in an amount within the range of 1 to 70 parts by weight per 100 parts of the base rubber. The core may be formed by mixing and forming the rubber composition using conventional techniques. Of course, embodiments are also envisioned wherein outer layers comprise such rubber-based compositions

Cores, intermediate/casing layers, and cover layers may be formed from an ionomeric material including ionomeric polymers, preferably highly-neutralized ionomers (HNP). In another embodiment, the intermediate layer of the golf ball is formed from an HNP material or a blend of HNP materials. The acid moieties of the HNP's, typically ethylene-based ionomers, are preferably neutralized greater than about 70%, more preferably greater than about 90%, and most preferably at least about 100%. The HNP's can be also be blended with a second polymer component, which, if containing an acid group, may also be neutralized. The second polymer component, which may be partially or fully neutralized, preferably comprises ionomeric copolymers and terpolymers, ionomer precursors, thermoplastics, polyamides, polycarbonates, polyesters, polyurethanes, polyureas, thermoplastic elastomers, polybutadiene rubber, balata, metallocene-catalyzed polymers (grafted and non-grafted), single-site polymers, high-crystalline acid polymers, cationic ionomers, and the like. HNP polymers typically have a material hardness of between about 20 and about 80 Shore D, and a flexural modulus of between about 3,000 psi and about 200,000 psi.

Non-limiting examples of suitable ionomers include partially neutralized ionomers, blends of two or more partially neutralized ionomers, highly neutralized ionomers, blends of two or more highly neutralized ionomers, and blends of one or more partially neutralized ionomers with one or more highly neutralized ionomers. Methods of preparing ionomers are well known, and are disclosed, for example, in U.S. Pat. No. 3,264,272, the entire disclosure of which is hereby incorporated herein by reference. The acid copolymer can be a direct copolymer wherein the polymer is polymerized by adding all monomers simultaneously, as disclosed, for example, in U.S. Pat. No. 4,351,931, the entire disclosure of which is hereby incorporated herein by reference. Alternatively, the acid copolymer can be a graft copolymer wherein a monomer is grafted onto an existing polymer, as disclosed, for example, in U.S. Patent Application Publication No. 2002/0013413, the entire disclosure of which is hereby incorporated herein by reference.

Any golf ball component, namely core, intermediate layer, cover, etc. may also be formed from or comprise or include or be blended or otherwise combined or mixed with any of the following compositions as known in the art to achieve particular desired golf ball characteristics:

(1) Polyurethanes, such as those prepared from polyols and diisocyanates or polyisocyanates and/or their prepolymers, and those disclosed in U.S. Pat. Nos. 5,334,673 and 6,506,851;

(2) Polyureas, such as those disclosed in U.S. Pat. Nos. 5,484,870 and 6,835,794; and

(3) Polyurethane-urea hybrids, blends or copolymers comprising urethane and urea segments.

Suitable polyurethane compositions comprise a reaction product of at least one polyisocyanate and at least one curing agent. The curing agent can include, for example, one or more polyols. The polyisocyanate can be combined with one or more polyols to form a prepolymer, which is then combined with the at least one curing agent. Thus, the polyols described herein are suitable for use in one or both components of the polyurethane material, i.e., as part of a prepolymer and in the curing agent. Suitable polyurethanes are described in U.S. Pat. No. 7,331,878, which is incorporated herein in its entirety by reference.

Examples of yet other materials which may be suitable for incorporating and coordinating in order to target and achieve desired playing characteristics or feel include plasticized thermoplastics, polyalkenamer compositions, polyester-based thermoplastic elastomers containing plasticizers, transparent or plasticized polyamides, Thiol-ene compositions, polyamide and anhydride-modified polyolefins, organic acid-modified polymers, and the like.

Meanwhile, the dimensions of each golf ball component such as the diameter of the core and respective thicknesses of the intermediate layer (s), cover layer(s) and coating layer(s) may be selected and coordinated as known in the art for targeting and achieving desired playing characteristics or feel. For example, the core may have a diameter of from about 1.47 inches (in.) to about 1.62 in.; the intermediate/casing layer may have a thickness of from about 0.025 in. to about 0.057 in.; a core and intermediate/casing layer, combined, may have a diameter of from about 1.57 in. to about 1.65 in.; the cover may have a thickness of from about 0.015 in. to about 0.055 in.; and any coating layers may have a combined thickness of from about 0.1 μm to about 100 μm, or from about 2 μm to about 50 μm, or from about 2 μm to about 30 μm. Meanwhile, each coating layer may have a thickness of from about 0.1 μm to about 50 μm, or from about 0.1 μm to about 25 μm, or from about 0.1 μm to about 14 μm, or from about 2 μm to about 9 μm, for example.

A golf ball of the invention may also incorporate indicia such any symbol, letter, group of letters, design, or the like, that can be added to the dimpled surface of a golf ball.

It will be appreciated that any known dimple pattern may be used with any number of dimples having any shape or size. For example, the number of dimples may be 252 to 456, or 330 to 392 and may comprise any width, depth, and edge angle. The parting line configuration of said pattern may be either a straight line or a staggered wave parting line (SWPL).

A golf ball of the invention may have any known compression and/or COR (coefficient of restitution). As disclosed in Jeff Dalton's Compression by Any Other Name, Science and Golf IV, Proceedings of the World Scientific Congress of Golf (Eric Thain ed., Routledge, 2002) (“J. Dalton”), several different methods can be used to measure compression, including Atti compression, Riehle compression, load/deflection measurements at a variety of fixed loads and offsets, and effective modulus. For purposes of the present invention, “compression” refers to Atti compression and is measured according to a known procedure, using an Atti compression test device, wherein a piston is used to compress a ball against a spring. The travel of the piston is fixed and the deflection of the spring is measured. The measurement of the deflection of the spring does not begin with its contact with the ball; rather, there is an offset of approximately the first 1.25 mm (0.05 inches) of the spring's deflection. Very low stiffness cores will not cause the spring to deflect by more than 1.25 mm and therefore have a zero compression measurement. The Atti compression tester is designed to measure objects having a diameter of 42.7 mm (1.68 inches); thus, smaller objects, such as golf ball cores, must be shimmed to a total height of 42.7 mm to obtain an accurate reading. Conversion from Atti compression to Riehle (cores), Riehle (balls), 100 kg deflection, 130-10 kg deflection or effective modulus can be carried out according to the formulas given in J. Dalton. Compression may be measured as described in McNamara et al., U.S. Pat. No. 7,777,871, the disclosure of which is hereby incorporated by reference.

The COR is determined according to a known procedure, wherein a golf ball or golf ball subassembly (for example, a golf ball core) is fired from an air cannon at two given velocities and a velocity of 125 ft/s is used for the calculations. Ballistic light screens are located between the air cannon and steel plate at a fixed distance to measure ball velocity. As the ball travels toward the steel plate, it activates each light screen and the ball's time period at each light screen is measured. This provides an incoming transit time period which is inversely proportional to the ball's incoming velocity. The ball makes impact with the steel plate and rebounds so it passes again through the light screens. As the rebounding ball activates each light screen, the ball's time period at each screen is measured. This provides an outgoing transit time period which is inversely proportional to the ball's outgoing velocity. The COR is then calculated as the ratio of the ball's outgoing transit time period to the ball's incoming transit time period (COR=Vₒᵤₜ/Vᵢₙ=Tᵢₙ/Tₒᵤₜ).

In any of these embodiments the single-layer core may be replaced with a 2 or more layer core wherein at least one core layer has a hardness gradient.

Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements. Furthermore, when numerical ranges of varying scope are set forth herein, it is contemplated that any combination of these values inclusive of the recited values may be used.

Although the golf ball of the invention has been described herein with reference to particular means and materials, it is to be understood that the invention is not limited to the particulars disclosed and extends to all equivalents within the scope of the claims.

When numerical lower limits and numerical upper limits are set forth herein, it is contemplated that any combination of these values may be used. Other than in the operating examples, or unless otherwise expressly specified, all of the numerical ranges, amounts, values and percentages such as those for amounts of materials and others in the specification may be read as if prefaced by the word “about” even though the term “about” may not expressly appear with the value, amount or range. Accordingly, unless indicated to the contrary, the numerical parameters set forth in the specification and attached claims are approximations that may vary depending upon the desired properties sought to be obtained by the present invention.

All patents, publications, test procedures, and other references cited herein, including priority documents, are fully incorporated by reference to the extent such disclosure is not inconsistent with this invention and for all jurisdictions in which such incorporation is permitted.

It is understood that the compositions and golf ball products described and illustrated herein represent only some embodiments of the invention. It is appreciated by those skilled in the art that various changes and additions can be made to compositions and products without departing from the spirit and scope of this invention. It is intended that all such embodiments be covered by the appended claims.

1. A golf ball comprising at least one layer L_{S} comprising a material L_{M} that is formed from a polymeric composition and a plurality of liquid droplets; wherein the plurality of liquid droplets are formed throughout the polymeric composition by combining the polymeric composition and a liquid that is immiscible in the polymeric composition.

2. The golf ball of claim 1, wherein the polymeric composition has a modulus M_{S1} and the material L_{M} has a modulus M_{S2} wherein (M_{S2}/M_{S1})>1.

3. The golf ball of claim 1, wherein the polymeric composition comprises at least one ionomer.

4. The golf ball of claim 1, wherein the liquid is a liquid at the temperature of golf ball use.

5. The golf ball of claim 4, wherein the liquid comprises at least one hydrocarbon oil.

6. The golf ball of claim 4, wherein the liquid comprises a mixture of hydrocarbon oils.

7. The golf ball of claim 1, wherein layer L_{S} is formed using dispersing aids.

8. The golf ball of claim 5, wherein the liquid is at least partially immiscible in the polymeric composition.

9. The golf ball of claim 5, wherein the liquid is completely immiscible in the polymeric composition.

10. The golf ball of claim 1, wherein the liquid and the polymeric composition are combined by at least one of high shear mixing, kneading, or compounding.

11. The golf ball of claim 1, wherein liquid droplet size and surface tension at an interface between each liquid droplet and the polymeric composition are coordinated.

12. The golf ball of claim 1, wherein the plurality of droplets comprises spherical droplets, aspherical droplets, or a combination thereof.

13. The golf ball of claim 12, wherein aspherical droplets are ovoid, ellipsoid or a combination thereof.

14. The golf ball of claim 12, comprising droplets that are oblate, prolate or a combination thereof.

15. The golf ball of claim 1, wherein each droplet has a diameter of up to about 100 nm.

16. The golf ball of claim 1, wherein each droplet has a diameter of less than about 5 μm.

17. The golf ball of claim 1, wherein each droplet has a diameter of up to about 10 μm.

18. The golf ball of claim 1, wherein each droplet has a diameter of from about 100 nm to about 5 μm.

19. The golf ball of claim 1, wherein each droplet has a diameter of from about 50 μm to about 100 μm.

20. The golf ball of claim 1, wherein each droplet has a diameter of up to about 100 μm.

21. The golf ball of claim 2, wherein M_{S2} is from about to about 1,000 psi to about 80,000 psi.

22. The golf ball of claim 2, wherein M_{S2} is from about to about 70,000 psi to about 500,000 psi.

23. The golf ball of claim 2, wherein (M_{S2}/M_{S1})>1.10.

24. The golf ball of claim 2, wherein (M_{S2}/M_{S1})>1.20.

25. The golf ball of claim 2, wherein (M_{S2}/M_{S1})>1.30.

26. The golf ball of claim 2, wherein (M_{S2}/M_{S1})>1.50.

27. The golf ball of claim 2, wherein (M_{S2}/M_{S1})>2.0.

28. The golf ball of claim 1, wherein Lₛ is least one intermediate layer.

29. The golf ball of claim 1, wherein Lₛ is a cover layer.

30. The golf ball of claim 1, wherein Lₛ is a coating layer disposed about a cover layer.

31. The golf ball of claim 1, wherein Lₛ is at least one of opaque, transparent or translucent.
